(19) United States
(12) Patent Application Publication
(10) Pub. No.: US 2010/0130089 A1
(43) Pub. Date: May 27, 2010

(54) METHOD FOR MANUFACTURING FLUORESCENT SUBSTRATE AND METHOD FOR MANUFACTURING IMAGE DISPLAY DEVICE

(75) Inventors: Hiroshi Higuchi, Atsugi-shi (JP); Atsushi Miida, Fujisawa-shi (JP); Daisuke Sasaguri, Yokohama-shi (JP); Shoshiro Saruta, Sagamihara-shi (JP); Takeo Ono, Sagamihara-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/622,341

(22) Filed: Nov. 19, 2009

(30) Foreign Application Priority Data
Nov. 21, 2008 (JP) 2008-298177

(51) Int. Cl. H01J 9/24; B05D 5/06

(52) U.S. Cl. 445/24; 427/67

(57) ABSTRACT

The method for manufacturing a fluorescent paste includes a process of applying a fluorescent paste including a sulfide fluorescent material and a binder resin onto a substrate, a first baking process of baking the substrate for a predetermined time at a first temperature that is equal to or lower than a temperature at which a generated amount of water has a maximum in a case where the fluorescent paste is measured by a TDP-MS method, and a second baking process of baking the substrate for a predetermined time at a second temperature that is equal to or higher than a temperature at which a generated amount of carbon dioxide has a minimum in a case where the fluorescent paste is measured by a TDP-MS method after the first baking process.

### BACKGROUND OF THE INVENTION

1. Field of the Invention

The present invention relates to a method for manufacturing a fluorescent substrate and also to a method for manufacturing an image display device having a fluorescent substrate.

2. Description of the Related Art

Image display devices in which an image is displayed by light emission from a fluorescent material, such as a FED (Field Emission Display) or PDP (Plasma Display Panel), are known. In the process of manufacturing a fluorescent substrate for such image display devices, a fluorescent paste is used in which fluorescent particles are dispersed in a binder resin and a solvent. Where screen printing is conducted by using the fluorescent paste and the fluorescent paste is then baked, the organic components of the binder resin are decomposed and a fluorescent substrate is formed.

In this case, where the fluorescent paste is insufficiently baked, the decomposition residue of the organic matter remains on the fluorescent substrate and emission luminance decreases. Therefore, it is desirable that the organic components of the binder resin be completely decomposed in the baking process.

A fluorescent paste in which a binder resin can be thermally decomposed at a lower temperature has been suggested as a fluorescent paste with excellent thermal decomposability (Japanese Patent Laid-Open No. 2006-28334.

### SUMMARY OF THE INVENTION

The invention provides a method inhibiting the deterioration of luminance of the fluorescent material in a process of baking the fluorescent paste.

The method for manufacturing a fluorescent substrate in accordance with the present invention includes a process of applying a fluorescent paste including a sulfide fluorescent material and a binder resin onto a substrate; a first baking process of baking for a predetermined time the substrate having the fluorescent paste applied thereto at a first temperature that is equal to or lower than a temperature at which a generated amount of water has a maximum in a case where the fluorescent paste is measured by a TDP-MS method; and a second baking process of baking for a predetermined time the substrate having the fluorescent paste applied thereto at a second temperature that is equal to or higher than a temperature at which a generated amount of carbon dioxide has a minimum in a case where the fluorescent paste is measured by a TDP-MS method after the first baking process.

With the invention, deterioration of luminance of the fluorescent material in the process of baking the fluorescent paste can be inhibited.

Further features of the present invention will become apparent from the following description of exemplary embodiments (with reference to the attached drawings).

### BRIEF DESCRIPTION OF THE DRAWINGS

FIG. 1 is a perspective view illustrating an example of the structure of an image display device.

FIG. 2 illustrates the structure of binder resin.

FIG. 3 shows the TDP-MS measurement results.

FIG. 4 shows a temperature profile in the baking process.

FIG. 5 shows a temperature profile in the baking process.

FIG. 6 shows the TDP-MS measurement results.

### DESCRIPTION OF THE EMBODIMENTS

### Embodiment 1

### Configuration of Image Display Device

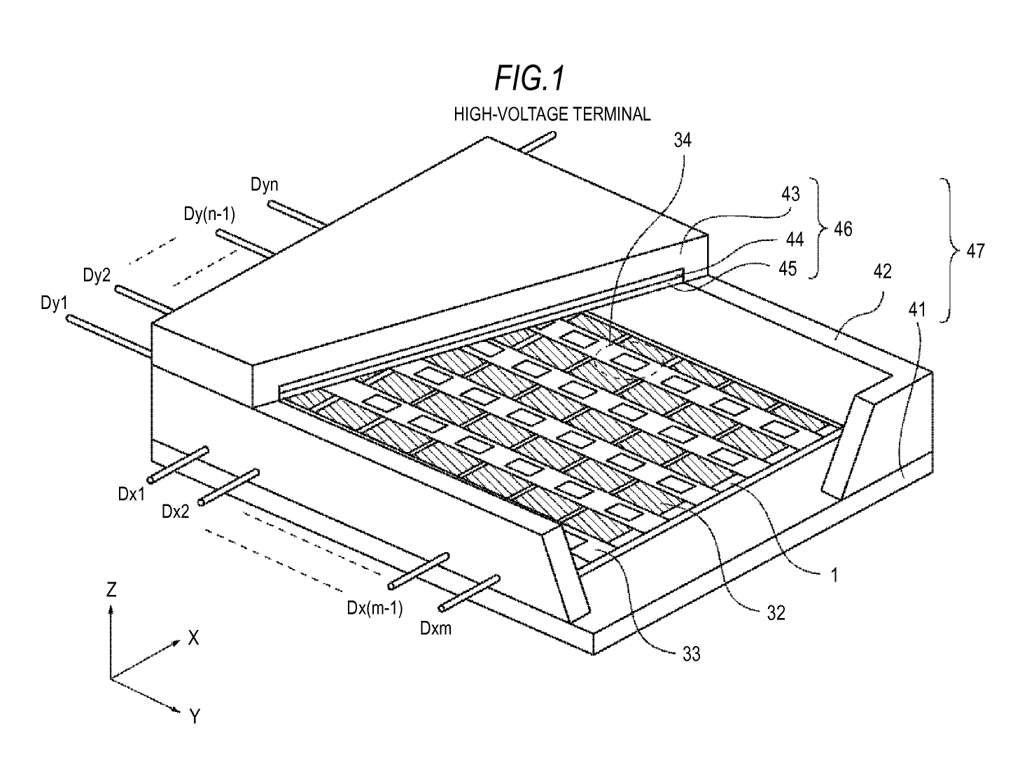

The configuration of an image display device will be explained below with reference to FIG. 1. In the present embodiment, an image display device using electron-emitting devices will be explained as the image display device.

FIG. 1 is a perspective view illustrating an example of the structure of the image display device having electron-emitting devices. Part of the structure is cut out to show the internal configuration. In the figure, the reference numeral 1 stands for a substrate, 32—a scan wiring, 33—a modulation wiring, 34—an electron-emitting device. An electron-emitting device of surface transmission type or an electron-emitting device of a spint type, MIM type, or carbon nanotube type can be used as the electron-emitting device 34. The reference numeral 41 stands for an electron source substrate fixed to the substrate 1, and 46—a fluorescent substrate in which a fluorescent material 44 and a metal back 45 as an anode electrode are formed on the inner surface of the glass substrate 43. The reference numeral 42 stands for a support frame. The electron source substrate 41 and fluorescent substrate 46 are attached by frit glass or the like to the support frame 42, thereby constituting an external enclosure 47. The electron source substrate 41 is provided mainly with the object of reinforcing the substrate 1. Therefore, in a case where the substrate 1 has by itself a sufficient strength, the electron source substrate 41 as a separate component is unnecessary. Further, by disposing a support body (not shown in the figure) called a spacer between the fluorescent substrate 46 and electron source substrate 41, it is possible to obtain a configuration with a sufficient strength against atmospheric pressure.

A total of m scan wirings 32 are connected to terminals Dx1, Dx2, . . . Dxm. A total of n modulation wirings 33 are connected to terminals Dy1, Dy2, . . . Dyn (m, n are both positive integers). An interlayer insulating layer (not shown in the figure) is provided between the m scanning wirings 32 and n modulation wirings 33, thereby electrically separating the wirings.

The high-voltage terminals are connected to the metal back 45, and a direct current voltage of, for example, 10 kV is supplied. This is an accelerating voltage serving to provide the electrons emitted from the electron-emitting device with energy sufficient to energize the fluorescent material.

(Method for Manufacturing Fluorescent Substrate)

A mechanism by which a modified layer is formed on the surface of a fluorescent material in the baking process will be described below before explaining the method for manufacturing a fluorescent substrate in accordance with the present invention.

In a case where a sulfide fluorescent material is used, the fluorescent material and water released in thermal decomposition of a binder resin react with each other in the process of baking the fluorescent paste. The inventors have found that this reaction results in the formation of a modified layer including a sulfate on the surface of the sulfide fluorescent material and that the emission luminance of the fluorescent material is decreased by this modified layer.

An example of using SrGa₂S₄:Eu as a sulfide fluorescent material and an acrylic resin as the binder resin will be explained below in greater detail. Where a fluorescent paste is baked at a temperature of 450° C. to 500° C., the binder resin is decomposed and H₂O or CO₂ is generated. Where this H₂O reacts with SrGa₂S₄:Eu, a sulfate such as SrₓGa_{y}(SO)₄ is formed.

The formation of the modified layer with a thickness of an order of several tens of nanometers on the fluorescent material surface was actually confirmed by cross-sectional TEM. When the fluorescent material before and after baking was measured by X-ray photoelectron spectroscopy, a spectrum indicating the presence of a sulfate on the fluorescent material after baking was confirmed. This modified layer makes no contribution to emission of the fluorescent material and decreases the electron energy. This is apparently why the modified layer is the reason for decreased emission luminance of the fluorescent material.

The reaction by which such a modified layer is formed is apparently enhanced by thermal energy. Therefore, it seems to be possible to inhibit the decrease in emission luminance of the fluorescent material by conducting baking in a state with low thermal energy.

The method for manufacturing a fluorescent substrate in accordance with the present invention will be described below based on specific embodiments.

(Fluorescent Paste)

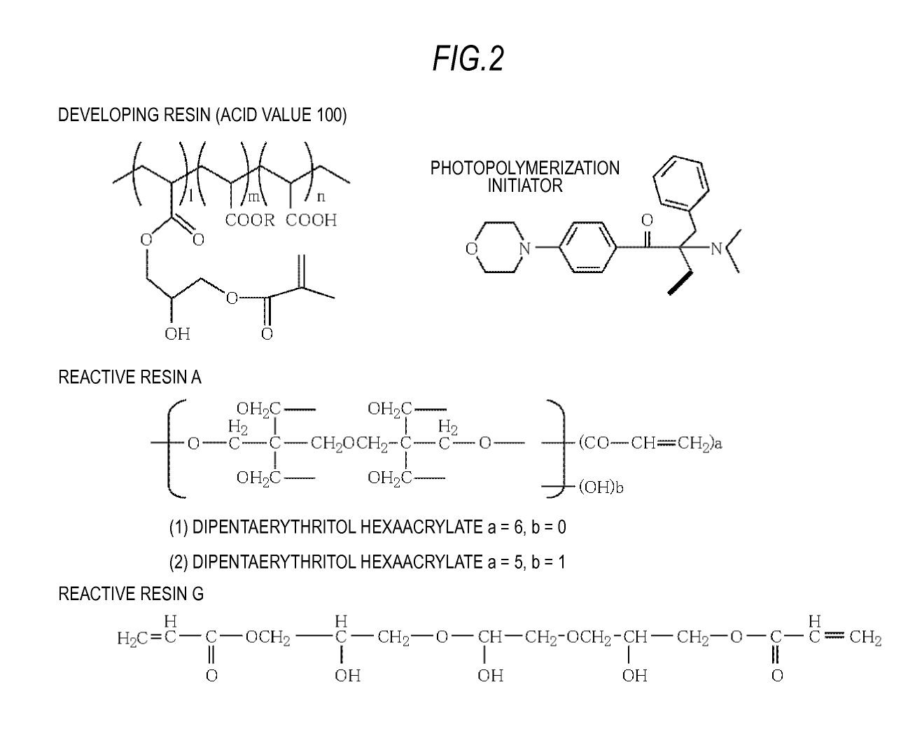

The fluorescent paste used in the present embodiment has SrGa₂S₄:Eu as a sulfide fluorescent material and the binder resin shown in FIG. 2. The fluorescent paste was produced by stirring and mixing a sulfide fluorescent material, a reactive resin, a developing resin (acid value 100), a photopolymerization initiator, and a solvent (diethylene glycol mono-n-butyl ether acetate; abbreviated hereinbelow as BCA) at ratios shown in Table 1.

TABLE 1

| Fluorescent paste composition | Ratio (wt. %) |
|---|---|
| SrGa₂S₄: Eu | 55.00 |
| Reactive resin A | 10.60 |
| Reactive resin G | 10.60 |
| Developing resin (acid value 100) | 22.05 |
| Photopolymerization initiator | 1.04 |
| Solvent (BCA) | 0.71 |

(Coating, Exposure, Development)

This fluorescent paste was coated on the entire surface of the glass substrate by screen printing. The substrate was then loaded for 7 min in a drying furnace at 170° C., and the solvent component was dried. As a result, a fluorescent layer including a resin was formed on the substrate. The film thickness after drying was about 12 μm. The substrate was exposed with a high-pressure mercury lamp and developed for 35 sec by using a 0.5% Na₂CO₃ aqueous solution. Finally, pure water rinsing was conducted for 30 sec and a fluorescent layer with a crosslinked resin was formed on the substrate.

(TDP-MS Measurements)

Part of the fluorescent layer was then scraped off and the resultant powder was used as a sample for TDP-MS (Temperature Programmed Desorption Mass Spectrometry) measurements.

The sample for TDP-MS measurements was placed in a crucible and allowed to stay for 30 min in a pseudo-air atmosphere (flow rate 50 mL/min) with He/O₂=80/20, followed by heating and analysis of the generated gas. The heating was conducted by raising the temperature from room temperature to 500° C. at a rate of 4° C./min.

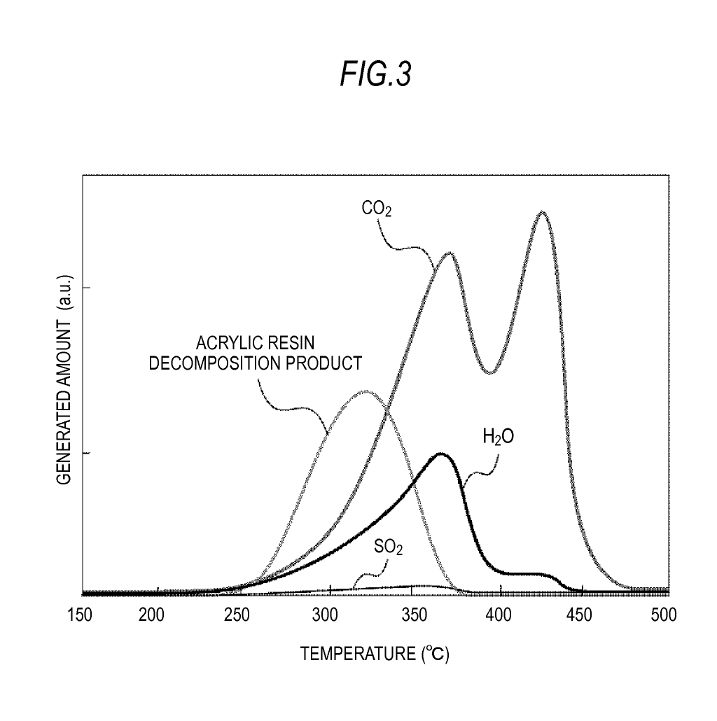

The results of TDP-MS measurements of the present embodiment are shown in FIG. 3. The amount of generated gas is plotted at the ordinate, and the gas generation temperature is plotted against the abscissa. Combustion and decomposition of the acrylic resin occurs within a range of from 250° C. to 500° C., and the generated gas is mainly the decomposition product of the resin, CO₂, and H₂O. Further, SO₂ was also confirmed to have been generated synchronously with the generation of H₂O. The SO₂ is apparently generated when H₂O reacts with SrGa₂S₄:Eu, forming a sulfate such as SrₓGa_{y}(SO₄)_{z}. Thus, a large amount of generated SO₂ means that a larger modified layer is formed on the surface of SrGa₂S₄:Eu.

The above-described results indicate that in order to suppress the deterioration of luminance in the baking process, it is preferred that H₂O be generated at a lower temperature and that the reaction between the SrGa₂S₄:Eu surface and H₂O be inhibited. The detailed baking method of the present embodiment that is based on this approach will be described below.

Two peaks were confirmed to be present with respect to CO₂ generation. Generally, where a resin is combusted, the supplied amount of oxygen is not balanced by the combustion rate and the resin is burnt out mainly in two combustion processes. In the first process, the supply of oxygen cannot follow the combustion rate, and in the initial combustion process, oxygen is mostly consumed on the rupture of CH bonds that have higher reactivity with oxygen. In this case, H₂O is generated together with CO₂. The carbon fraction that has not reacted in this process remains as an organic residue. In the second process, combustion further advances, sufficient amount of oxygen is supplied, and the combustion of residue proceeds. A CO₂ peak is also observed in this process. The organic residue is a carbon-rich residue such as amorphous carbon, and this residue hinders the penetration of electron beam, causes reabsorption of emitted light and can cause decrease in luminance of the fluorescent material. Therefore, the organic residue has to be eventually decomposed entirely in order to inhibit the decrease in luminance.

(Baking)

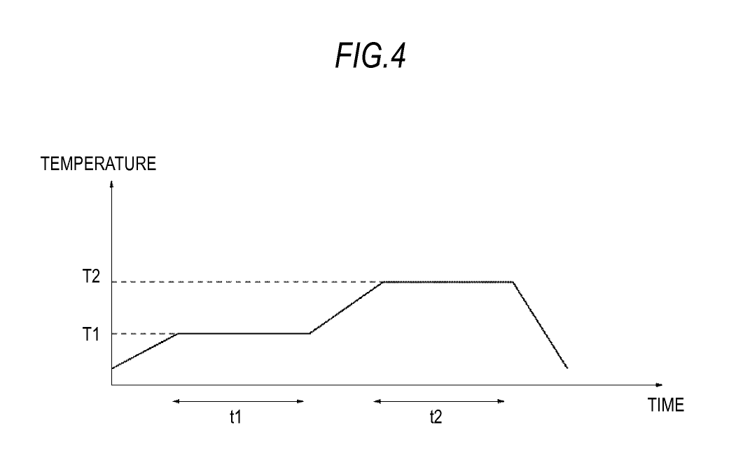

The temperature profile in the baking process of the present embodiment is shown in FIG. 4. Time is plotted against the abscissa, and baking temperature is plotted against the ordinate. The present embodiment involves a first baking process in which baking is performed for a time t1 at a baking temperature T1 (corresponds to “first temperature”) and a second baking process in which baking is performed for a time t2 at a baking temperature T2 (corresponds to “second temperature”).

A temperature that is equal to or lower than a temperature at which the generated amount of water has a maximum in a case where the fluorescent paste is measured by the TDP-MS method was taken as T1. This is because where T1 is taken as a temperature that is higher than the temperature at which the generated amount of water has a maximum, the reaction between H₂O and SrGa₂S₄:Eu advances. A temperature that is equal to or higher than a temperature at which a generated amount of carbon dioxide has a minimum in a case where the fluorescent paste is measured by a TDP-MS method was taken as T2. This is because where T2 is taken as a temperature that is lower than the temperature at which the generated amount of carbon dioxide has a minimum, the organic residue that remained in the first baking process cannot be sufficiently decomposed. It is preferred that a temperature equal to or higher than a temperature on a high-temperature side from among the temperatures at which the generated amount of carbon dioxide has a maximum in a case where the fluorescent paste is measured by a TDP-MS method, that is, a temperature equal to or higher than a second peak temperature of carbon dioxide, be taken as T2. This is because by taking the temperature higher than T2, it is possible to decompose more fully the organic residue.

As shown in FIG. 3, in the present embodiment, the peaks of H₂O and CO₂ are present in the vicinity of 360° C. Further, a minimum of CO₂ is present in the vicinity of 390° C. Furthermore, the second peak of CO₂ is present in the vicinity of 420° C.

Accordingly, in the present embodiment, the first baking process was performed at T1=350° C. and t1=15 h and then the second baking process was performed at T2=500° C. and t2=90 min.

(Measurement of Luminance)

The fluorescent material was scraped off the baked fluorescent substrate and cathode luminescence luminance measurement was conducted. The luminance measurement results are shown in Table 2.

TABLE 2

| | Relative luminance |
|---|---|
| Baking | (%) |
| No baking (initial powder) | 100 |
| Embodiment 1 | 86 |
| Embodiment 2 | 88 |
| Embodiment 3 | 89 |
| Embodiment 4 | 79 |
| Comparative Example 1 | 77 |

Where the luminance of the un-baked material (initial powder before the paste was produced) was taken as 100%, the luminance in the present embodiment was 86%.

### Embodiment 2

This embodiment was similar to Embodiment 1, except that the temperature profile in the baking process was different from that of Embodiment 1.

In the present embodiment, the first baking process was performed at T1=330° C. and t1=15 h and then the second baking process was performed at T2=500° C. and t2=90 min.

Where the luminance of the un-baked material (initial powder before the paste was produced) was taken as 100%, the luminance in the present embodiment was 88%.

### Embodiment 3

This embodiment was similar to Embodiment 1, except that the temperature profile in the baking process was different from that of Embodiment 1.

In the present embodiment, the first baking process was performed at T1=350° C. and t1=10 h and then the second baking process was performed at T2=500° C. and t2=90 min.

Where the luminance of the un-baked material (initial powder before the paste was produced) was taken as 100%, the luminance in the present embodiment was 89%.

### Embodiment 4

This embodiment was similar to Embodiment 1, except that the temperature profile in the baking process was different from that of Embodiment 1.

In the present embodiment, the first baking process was performed at T1=350° C. and t1=90 min and then the second baking process was performed at T2=500° C. and t2=90 min.

Where the luminance of the un-baked material (initial powder before the paste was produced) was taken as 100%, the luminance in the present embodiment was 79%.

### Comparative Example 1

This comparative example was similar to Embodiment 1, except that the temperature profile in the baking process was different from that of Embodiment 1.

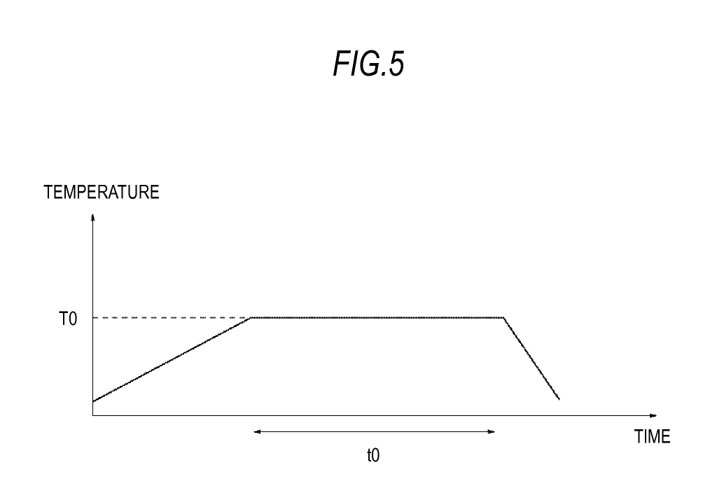

The temperature profile in the baking process of the present comparative example is shown in FIG. 5.

In the present comparative example, the temperature was raised to a baking temperature T0 and then the baking was conducted for a time t0 at the temperature T0 as in the conventional baking process. In the present comparative example, T0 was 500° C. and t0 was 90 min.

Where the luminance of the un-baked material (initial powder before the paste was produced) was taken as 100%, the luminance in the present embodiment was 77%.

The measurement results obtained in Embodiments 1 to 4 and Comparative Example 1 demonstrate that by conducting two-stage baking, as in the embodiment, it is possible to inhibit the deterioration of luminance of the fluorescent material in the process of baking the fluorescent paste.

It is also clear that by setting the first temperature T1 to 330°, which is the temperature lower than the temperature in Embodiment 1, as in Embodiment 2, it is possible to prevent the deterioration of luminance of the fluorescent material even more effectively. This is apparently because the reaction of water at the fluorescent material surface could be inhibited.

Further, by setting t1 to 10 h, which is the time shorter than that in Embodiment 1, as in Embodiment 3, it is possible to prevent the deterioration of luminance of the fluorescent material even more effectively.

Where t1 is set to 90 min, which is the time still shorter than that in Embodiment 3, as in Embodiment 4, it is possible to inhibit the deterioration of luminance by comparison with that of Comparative Example 1, but it is clear that the luminance has degraded with respect to that of Embodiments 1 to 3. This is apparently because the time t1 of the first baking process in Embodiment 4 was too short and the resin could not be sufficiently decomposed in the first baking process. The present invention does not exclude Embodiment 4, but it is preferred that a larger amount of H₂O be generated at a lower temperature over a short period.

### Embodiment 5

The fluorescent paste used in the present embodiment was different from those of Embodiments 1 to 4 and Comparative Example 1.

(Fluorescent Paste)

The fluorescent paste used in the present embodiment used ZnS:Cu,Al (represented hereinbelow as ZnS in the present embodiment) as a sulfide fluorescent material and ethyl cellulose as a binder resin. The sulfide fluorescent material, ethyl cellulose, and solvent were stirred and mixed at ratios shown in Table 3 and a fluorescent paste was produced.

Various kinds of ethyl cellulose that differ in physical properties are marketed and typically a plurality of kinds of ethyl cellulose are mixed to adjust viscosity and solubility. In the present embodiment, N-200 and STD-100 (Fuji Shikiso Co., Ltd.) that differ in degree of polymerization and degree of ethylating were used.

TABLE 3

| Fluorescent paste composition | | Ratio (wt. %) |
|---|---|---|
| ZnS: Cu, Al | | 55.00 |
| Ethyl cellulose | N-200 | 1.86 |
| | STD-100 | 1.52 |
| Solvent | BCA | 31.22 |
| | α-Terpineol | 10.40 |

(Coating)

The fluorescent paste was coated by screen printing on the glass. Because ethyl cellulose is not photosensitive, the exposure and development were not conducted. The substrate was loaded for 7 min in a drying furnace at 130° C. and the solvent component was dried. As a result, a fluorescent layer including ethyl cellulose was formed on the substrate. The film thickness after drying was about 12 μm.

(TDP-MS Measurements)

The powder obtained by scraping off part of the fluorescent layer was used as the sample for TDP-MS measurements.

The sample for TDP-MS measurements was placed in a crucible and allowed to stay for 30 min or more in a pseudo-air atmosphere (flow rate 50 mL/min) with He/O₂=80/20, followed by heating and analysis of the generated gas. The heating was conducted by raising the temperature from room temperature to 500° C. at a rate of 4° C./min.

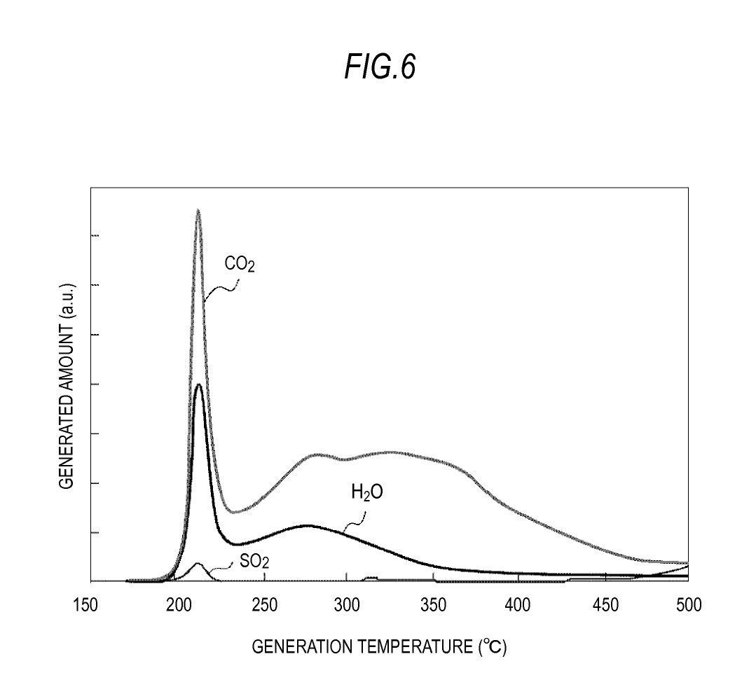

The results of TDP-MS measurements of the present embodiment are shown in FIG. 6. The graphs are shown only for the extracted CO₂, H₂O, and SO₂. Combustion and decomposition of ethyl cellulose occur within a range of from 200° C. to 500° C., and the generated gas is mainly the decomposition product of the resin, CO₂, and H₂O. Further, SO₂ was also confirmed to have been generated synchronously with the generation of H₂O. The SO₂ is apparently generated when H₂O reacts with ZnS. Thus, a large amount of generated SO₂ means that a larger modified layer is formed on the ZnS surface.

The above-described results indicate that, similarly to the above-described embodiment, in order to suppress the deterioration of luminance in the baking process, it is preferred that H₂O be generated at a lower temperature and that the reaction between the ZnS surface and H₂O be inhibited.

In the present embodiment, a plurality of peaks were confirmed with respect to CO₂ generation. The peak that is in the lowermost temperature range is present close to 220° C. This peak is synchronous with the peak in which H₂O has a maximum. Therefore, this peak appears because the supply of oxygen cannot follow the combustion rate and a larger amount of oxygen is consumed on the breakage of CH bonds that react more easily with oxygen in the initial combustion process. The carbon fraction that has not reacted in this process remains as an organic residue. The second peak of CO₂ is present close to 280° C., and the third peak of CO₂ is present close to 320° C. These peaks occur because combustion advances after the first peak, sufficient amount of oxygen is supplied, and combustion of the residue advances. The organic residue is a carbon-rich residue such as amorphous carbon, and this residue hinders the penetration of electron beam, causes reabsorption of emitted light, and can cause decrease in luminance of the fluorescent material. Therefore, the organic residue has to be eventually decomposed entirely in order to inhibit the decrease in luminance.

(Baking)

The temperature profile in the baking process of the present embodiment is shown in FIG. 4, similarly to Embodiments 1 to 4.

A temperature that is equal to or lower than a temperature at which the generated amount of water has a maximum in a case where the fluorescent paste was measured by the TDP-MS method was taken as T1. This is because where T1 is taken as a temperature that is higher than the temperature at which the generated amount of water has a maximum, the reaction between H₂O and ZnS advances. A temperature that is equal to or higher than a temperature at which a generated amount of carbon dioxide has a minimum in a case where the fluorescent paste was measured by a TDP-MS method was taken as T2. This is because where T2 is taken as a temperature that is lower than the temperature at which the generated amount of carbon dioxide has a minimum, the organic residue that remained in the first baking process cannot be sufficiently decomposed.

It is preferred that a temperature equal to or higher than a temperature on a high-temperature side from among the temperatures at which the generated amount of carbon dioxide has a maximum in a case where the fluorescent paste is measured by a TDP-MS method, that is, a temperature equal to or higher than a second peak temperature of carbon dioxide, be taken as T2. This is because by taking the temperature higher than T2, it is possible to decompose more fully the organic residue. In a case where three or more peaks of CO₂ are present, as in the present embodiment, the temperature on a high-temperature side from among the temperatures at which the generated amount of carbon dioxide has a maximum means a temperature equal to or higher than that of the second peak.

As described hereinabove, in the present embodiment, the peaks of H₂O and CO₂ are present in the vicinity of 220° C. Further, a minimum of CO₂ is present in the vicinity of 240° C. Furthermore, the second peak of CO₂ is present in the vicinity of 280° C. and the third peak of CO₂ is present in the vicinity of 320° C.

Accordingly, in the present embodiment, the first baking process was performed at T1=210° C. and t1==15 h and then the second baking process was performed at T2=500° C. and t2=90 min.

(Measurement of Luminance)

The fluorescent material was scraped off the baked fluorescent substrate and cathode luminescence luminance measurements were conducted. The luminance measurement results are shown in Table 4.

TABLE 4

| | Relative luminance |
|---|---|
| Baking | (%) |
| No baking (initial powder) | 100 |
| Embodiment 5 | 93 |
| Comparative Example 2 | 87 |

Where the luminance of the un-baked material (initial powder before the paste was produced) was taken as 100%, the luminance in the present embodiment was 93%.

### Comparative Example 2

This comparative example was similar to Embodiment 5, except that the temperature profile in the baking process was different from that of Embodiment 5.

The temperature profile in the baking process of the present comparative example is shown in FIG. 5.

In the present comparative example, the temperature was raised to a baking temperature T0 and then the baking was conducted for a time t0 at the temperature T0 as in the conventional baking process. In the present comparative example, T0 was 500° C. and t0 was 90 min.

Where the luminance of the un-baked material (initial powder before the paste was produced) was taken as 100%, the luminance in the present embodiment was 87%.

The measurement results obtained in Embodiment 5 and Comparative Example 2 demonstrate that by conducting two-stage baking, as in the embodiment, it is possible to inhibit the deterioration of luminance of the fluorescent material in the process of baking the fluorescent paste.

### Other Embodiments

### Sulfide Fluorescent Material

In the above-described embodiments, SrGa₂S₄:Eu, ZnS:Cu,Al were used as the sulfide fluorescent materials, but the present invention is not limited to these sulfide fluorescent materials. For example, sulfide fluorescent materials such as SrGa₂S₄:Ce³⁺, CaGa₂S₄:Ce³⁺, ZnS:Ag,Al. ZnS:Cu,Al, ZnS:Ag,Cu, SrGa₂S₄:Eu²⁺, ZnS:Au,Cu,Al, and CaS:Eu³⁺ can be used in accordance with the present invention.

(Fluorescent Paste)

In the above-described embodiments, the compositions shown in Table 1 and Table 3 were used as the fluorescent paste, but the present invention is not limited to these fluorescent pastes. Thus, the composition of the fluorescent paste can be appropriately changed correspondingly to the light emission characteristic required for the fluorescent substrate, and any fluorescent paste can be used in accordance with the present invention.

(Baking)

In the above-described embodiments, two-stage baking such as shown in FIG. 4 was performed, but the invention does not exclude baking including three or more stages. Thus, providing that a first baking process of baking for a predetermined time the substrate having the fluorescent paste applied thereto at a first temperature that is equal to or lower than a temperature at which a generated amount of water has a maximum in a case where the fluorescent paste is measured by a TDP-MS method and a second baking process of baking for a predetermined time the substrate having the fluorescent paste applied thereto at a second temperature that is equal to or higher than a temperature at which a generated amount of carbon dioxide has a minimum in a case where the fluorescent paste is measured by a TDP-MS method after the first baking process are present, a process of baking at temperatures different from the first temperature and second temperature may be present between the first baking process and second baking process. Further, a process of baking at a temperature different from the second temperature may be present after the second baking process.

(Image Display Device)

In the above-described embodiments, fluorescent substrates of FED (Field Emission Display) were considered by way of example, but the invention is not limited to this configuration. For example, the invention is also applicable to fluorescent substrates of PDP (Plasma Display Panel).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-298177, filed Nov. 21, 2008, which is hereby incorporated by reference herein in its entirety.

What is claimed is:

1. A method for manufacturing a fluorescent substrate, comprising:
a process of applying a fluorescent paste including a sulfide fluorescent material and a binder resin onto a substrate;
a first baking process of baking for a predetermined time the substrate having the fluorescent paste applied thereto at a first temperature that is equal to or lower than a temperature at which a generated amount of water has a maximum in a case where the fluorescent paste is measured by a TDP-MS method; and
a second baking process of baking for a predetermined time the substrate having the fluorescent paste applied thereto at a second temperature that is equal to or higher than a temperature at which a generated amount of carbon dioxide has a minimum in a case where the fluorescent paste is measured by a TDP-MS method after the first baking process.

2. The method for manufacturing a fluorescent substrate according to claim 1, wherein the binder resin is an acrylic resin.

3. The method for manufacturing a fluorescent substrate according to claim 1, wherein the binder resin is ethyl cellulose.

4. The method for manufacturing a fluorescent substrate according to claim 1, wherein the second temperature is equal to or higher than a temperature on a high-temperature side from among the temperatures at which the generated amount of carbon dioxide has a maximum in a case where the fluorescent paste is measured by a TDP-MS method after the first baking process.

5. A method for manufacturing an image display device having a fluorescent substrate, wherein
the fluorescent substrate is manufactured by the method for manufacturing a fluorescent substrate according to claim 1.

6. The method for manufacturing an image display device according to claim 5, wherein the image display device has an electron source substrate provided with electron-emitting devices.
